(19) United States
(12) Patent Application Publication
(10) Pub. No.: US 2026/0134316 A1
(43) Pub. Date: May 14, 2026

(54) ENTANGLEMENT SCHEDULING AND DISTRIBUTION IN QUANTUM DATACENTERS

(71) Applicant: Cisco Technology, Inc., San Jose, CA (US)

(72) Inventors: Stephen DiAdamo, Munich (DE); Francesco Vista, Barletta (IT); Eneet Kaur, Somerville, MA (US); Reza Nejabati, Los Angeles, CA (US)

(21) Appl. No.: 18/928,459

(22) Filed: Oct. 28, 2024

Related U.S. Application Data
(60) Provisional application No. 63/673,909, filed on Jul. 22, 2024.

(51) Int. Cl. G06N 10/20; G06N 10/40

(52) U.S. Cl. CPC G06N 10/20; G06N 10/40

(57) ABSTRACT

An example embodiment receives a traffic shape (or information to generate a traffic shape) and produces an entanglement resource distribution schedule for a distributed quantum algorithm or circuit. An embodiment generates a timeline indicating when entanglement resources are needed amongst network nodes in order to perform the distributed quantum circuit. A scheduler generates a collection of entanglement requests to be fulfilled based on the timeline.

### CROSS-REFERENCE TO RELATED APPLICATION

This application claims priority to U.S. Provisional Patent Application Ser. No. 63/673,909, entitled “Entanglement Scheduling and Distribution in Quantum Datacenters” and filed on Jul. 22, 2024, the entirety of which is incorporated herein by reference.

### TECHNICAL FIELD

The present disclosure relates to quantum computing.

### BACKGROUND

Quantum computing holds significant potential for tackling complex computational tasks due to its unique physical properties that leverage phenomena, such as entanglement and superposition. However, quantum algorithms often require a huge number of quantum bits (qubits). Despite advancements in quantum computing, existing architectures in the era of Noisy Intermediate-Scale Quantum (NISQ) computing are limited by fabrication process and hardware noise. Typically, these systems implement only a few tens or hundreds of qubits per machine.

A Quantum Data Center (QDC) architecture has emerged as a promising approach to address a challenge of a limited numbers of qubits within one quantum processing unit. The QDC architecture interconnects quantum computers (similar to concepts for traditional datacenters) to significantly enhance computational capacity by distributing quantum algorithms. This distributed approach allows division of a monolithic quantum algorithm into sub-circuits, fostering task parallelism and scalability.

In order to perform quantum networking applications, quantum entanglement is distributed to network nodes to be used as a resource. However, this requires a demand schedule from the network nodes for entanglement resources needed to execute their application (e.g., distributed quantum algorithms).

### BRIEF DESCRIPTION OF THE DRAWINGS

FIG. 1 is a block diagram of a high-level quantum datacenter architecture, according to an example embodiment.

FIG. 2 is a block diagram of an entanglement scheduling and distribution framework, according to an example embodiment.

FIG. 3 illustrates a flowchart of a method for scheduling entanglement based on a greedy approach, according to an example embodiment.

FIG. 4 illustrates a flowchart of a method for determining an entanglement event for an entanglement request, according to an example embodiment.

FIG. 5 illustrates a flowchart of a method for determining an entanglement event for an entanglement request based on a time for a quantum switch to change state, according to an example embodiment.

FIG. 6 illustrates results of assigning entanglement resources to entanglement requests produced by an example embodiment.

FIG. 7 illustrates a flowchart of a generalized method for distribution of entanglement resources for a distributed quantum circuit, according to an example embodiment.

FIG. 8 illustrates a hardware block diagram of a computing device configured to perform functions associated with operations discussed herein, according to an example embodiment.

### DETAILED DESCRIPTION

### Overview

Provided herein are techniques to receive a traffic shape (or information to generate a traffic shape) and produce an entanglement resource distribution schedule for a distributed quantum algorithm or circuit. A timeline is generated indicating when entanglement resources are needed amongst network nodes in order to perform the distributed quantum circuit, and a collection of entanglement requests are generated to be fulfilled based on the timeline.

### Example Embodiments

Example embodiments receive a traffic shape (or information to generate a traffic shape) and produce an entanglement resource distribution schedule for a distributed quantum algorithm or circuit. An embodiment generates a timeline indicating when entanglement resources are needed amongst network nodes in order to perform the distributed quantum circuit. A scheduler generates a collection of entanglement requests to be fulfilled based on the timeline.

An embodiment uses a distributed quantum algorithm or program structure to extract communication steps that are used to generate entanglement requests and elements to be scheduled. The structure includes particular metadata to allow for scheduling. The frequency of devices, such as a quantum source and switch, are used to generate entanglement (Einstein-Podolsky-Rosen (EPR)) events which can be matched with the entanglement requests to fulfill those requests. Properties of quantum memories of quantum computers and a user-specified minimum fidelity are used to determine a maximum time ahead for an entanglement request for sending and storing quantum entanglement. A user is allowed to specify their needed entanglement fidelity. Further, loss properties of hardware are used to attach additional EPR events to an entanglement request to ensure fulfilment of that request. A quantity of rejected requests is used to remove quantum programs from an execution schedule. A negotiation scheme is used to determine if quantities of accepted (or fulfilled) and rejected entanglement requests are acceptable. When the quantities of the accepted and rejected entanglement requests are not acceptable, the rejected requests are re-processed to generate more accepted requests and maximize a number of jobs executed simultaneously. The combinations of jobs executed simultaneously are used to minimize total execution runtime, based on quantum gate times. In addition, a set of entanglement requests is used to generate control instructions for an entanglement generation switch.

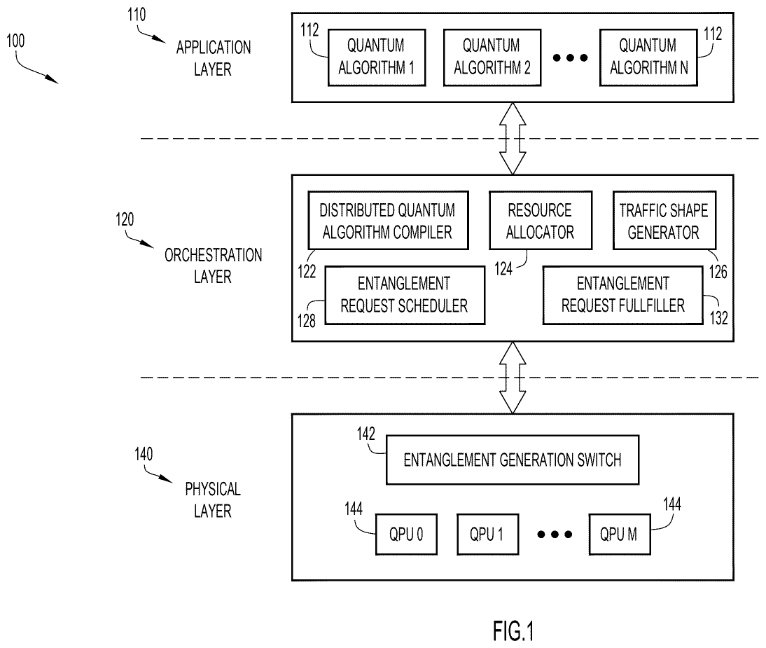

FIG. 1 illustrates a block diagram of a high-level architecture of a quantum network datacenter 100, according to an example embodiment. Quantum network datacenter 100 includes an application layer 110, an orchestration layer 120, and a physical layer 140. Application layer 110 includes different quantum algorithms 112 (or circuits) (e.g., Quantum Algorithm 1 to Quantum Algorithm N as viewed in FIG. 1) that a user submits to the quantum network datacenter for execution.

Physical layer 140 includes quantum processing units (QPUs) 144 (e.g., QPU 0 to QPU M as viewed in FIG. 1) that perform quantum algorithms 112 and are interconnected by an entanglement generation switch 142. The entanglement generation switch includes a quantum source and a reconfigurable optical switch. QPUs 144 handle data qubits that are dedicated to executing quantum circuits (e.g., quantum algorithms 112), and communication qubits that are used for inter-QPU communication. The quantum source includes a device capable of generating entangled photon pairs. A conventional technique to create and utilize entanglement involves producing polarization-entangled photons by spontaneous parametric down-conversion (SPDC). This may be achieved by directing a laser beam toward nonlinear crystals. The reconfigurable optical switch directs the entangled photon (EPR) pairs from entanglement generation switch 142 to QPUs 144 for executing the quantum circuits.

Orchestration layer 120 manages physical layer 140, and serves as an interface between application layer 110 and physical layer 140. Orchestration layer 120 includes a distributed quantum algorithm compiler 122, a resource allocator 124, a traffic shape generator 126, an entanglement request scheduler 128, and an entanglement request fulfiller 132. The orchestration layer (prior to execution of a quantum algorithm 112) compiles distributed quantum algorithms and allocates resources. These tasks can be optimized together to enhance efficiency of network resource utilization.

Distributed quantum algorithm compiler 122 translates each quantum algorithm or algorithm 112 (or circuit) into a distributed quantum circuit that is compatible with hardware constraints. For example, a quantum algorithm 112 (or circuit) may include a series of quantum gates (e.g., controlled NOT (CNOT) gates, etc.) that are applied to a series of qubits. Quantum gates are considered non-local gates when the qubits for these quantum gates reside on different QPUs, thereby requiring expensive entangled (EPR) pairs to operate the gates. Quantum gates that have their qubits on the same QPU are considered local gates (without requiring EPR pairs to operate the gates). The distributed quantum algorithm compiler maps qubits of a quantum algorithm 112 (or circuit) to physical qubits of QPUs 144 and partitions the quantum circuit into multiple segments.

Resource allocator 124 assigns each segment of quantum algorithm 112 (or circuit) to a QPU 144 based on a number of available qubits in each QPU. Traffic shape generator 126 determines a traffic shape (or time associated data) of entanglement requests for the quantum circuit, while entanglement request fulfiller 132 evaluates a number of entanglement requests that can be fulfilled. Entanglement request scheduler 128 schedules distribution of entanglement resources according to the fulfilled entanglement requests. Example embodiments provide techniques to schedule generation and distribution of EPR pairs among QPUs for distributed processing of a quantum circuit. An entanglement generation switch 142 (e.g. entanglement source and reconfigurable optical switch) is controlled according to the scheduling to generate and distribute the EPR pairs at appropriate times to the QPUs to execute the distributed quantum circuit. Although example embodiments are described with respect to a quantum datacenter, it will be appreciated that the example embodiments may be applied to any types of quantum networks.

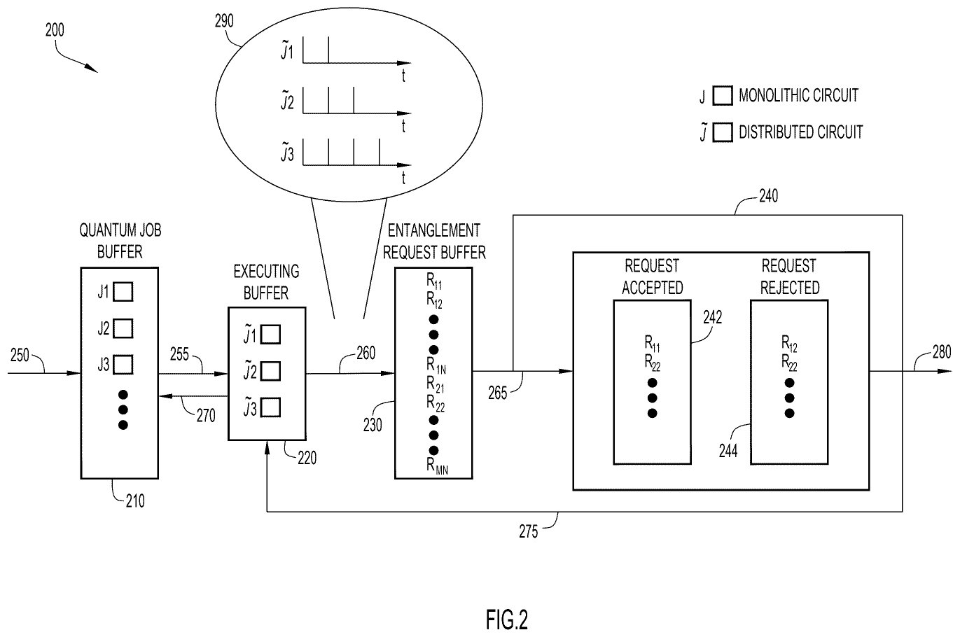

With continued reference to FIG. 1, FIG. 2 is a block diagram of an entanglement scheduling and distribution framework 200, according to an example embodiment. By way of example, entanglement scheduling and distribution framework 200 may operate within orchestration layer 120 of quantum network datacenter 100. Initially, incoming quantum algorithms (e.g., J1 to J3 as viewed in FIG. 2), preferably in the form of monolithic quantum circuits, are stored within a quantum job buffer 210 at flow 250.

Resource allocator 124 of orchestration layer 120 is responsible for assigning qubit resources within QPUs 144 of physical layer 140 to a monolithic quantum circuit from quantum job buffer 210 based on the underlying hardware status in terms of available QPUs and qubits. Distributed quantum algorithm compiler 122 translates the monolithic quantum circuits to distributed quantum circuits executable by computer or processor executable jobs (e.g., Ĵ1 to Ĵ3 as viewed in FIG. 2) based on the resource allocation at flow 255. The distributed quantum algorithm compiler 122 preferably determines jobs (executing distributed quantum circuits) that maximize a number of qubits per QPU used, while minimizing entanglement requests needed. These jobs are stored in an executing buffer 220.

However, in order to execute the jobs, entanglement requests for the jobs are evaluated. Traffic shape generator 126 of orchestration layer 120 extracts a traffic shape (or time associated data) indicating an exact time of an entanglement request and the QPUs 144 between which entanglement is to be established for each distributed quantum circuit within executing buffer 220 at flow 260. By way of example, the traffic shape may be represented by timelines 290 showing entanglement requests for jobs Ĵ1 to Ĵ3 over time. The entanglement requests (e.g., R₁₁ to R_{MN} as viewed in FIG. 2) are sorted by time and stored in an entanglement request buffer 230.

Entanglement request fulfiller 132 of orchestration layer 120 evaluates the entanglement requests in entanglement request buffer 230 based on hardware resources of entanglement generation switch 142. Entanglement request scheduler 128 maximizes a number of jobs (or distributed quantum circuits) for which all entanglement requests can be fulfilled at flow 265. The accepted (or fulfilled) entanglement requests are stored in a buffer 242, while rejected entanglement requests are stored in a buffer 244.

When some requests of a job (or distributed quantum circuit) are unfulfilled, the job is removed from executing buffer 220 at flow 270. Another job (or distributed quantum circuit) may be placed in executing buffer 220 at flow 275 and the above process may be repeated from flow 260. Entanglement request scheduler 128 produces a switch scheduling plan or entanglement resource distribution schedule and provides an estimate of a total time required for job execution at flow 280. In addition, when quantities of accepted and rejected entanglement requests are unacceptable (e.g., fail to satisfy thresholds, etc.), rejected entanglement requests may be provided at flow 240 for re-processing at flow 265 to produce more accepted entanglement requests.

In addition, an embodiment can determine an exact execution runtime of quantum jobs in executing buffer 220 based on the allocation of quantum resources. The resource allocation may be performed such that multiple quantum jobs (or distributed quantum circuits) can be scheduled to execute simultaneously. When quantum jobs are scheduled simultaneously, the runtime is minimized or reduced (e.g., to the maximum runtime of the collection of quantum jobs running together) in comparison to sequential execution. Accordingly, the embodiment can select the quantum jobs in executing buffer 220 providing simultaneous execution to minimize runtime under the constraint that these jobs also have fulfillable requests.

While conventional approaches typically model end-to-end entanglement requests using stochastic processes, an embodiment generates the entanglement requests based on actual requests from the distributed quantum algorithm compiler for implementing remote (or non-local) gates and specific operational times of underlying QPUs. The distributed quantum circuit is represented as a directed acyclic graph (DAG) that shows dependencies of each gate and enables determination of operations that can occur simultaneously (in the same layer). The embodiment sweeps through the layers to identify an entanglement generation sub-circuit and measurement process. When one of these is found, time is tracked by considering a maximum value of a duration of a longest operation gate within the layer.

In order to derive a switch scheduling plan (or entanglement resource distribution schedule), different timing aspects of a quantum architecture are considered. In an embodiment, a star topology may be used, where the entanglement source of entanglement generation switch 142 generates a Bell pair every time interval, tₑₚᵣ, to the appropriate QPUs through the reconfigurable optical switch that needs time, t_{switch}, to reconfigure its internal state. Thus, a time, tᵣ, needed to satisfy consecutive requests may be expressed as:

$${t}_{r} = {t}_{epr} when the switch does not need to be reconfigured ; or$$

$${t}_{r} = {t}_{epr} + {t}_{switch} when the switch needs to be reconfigured .$$

On the other hand, qubits in quantum memories undergo a time-dependent decoherence according to a memory relaxation time T1 and dephasing time T2. Specifically, a quantum state, ρ, may remain idle for time Δt, and the effect can be defined by applying a quantum channel which may be expressed as:

$$ρ ’ \to {E}_{0} ρ E {†}_{0} + {E}_{1} ρ E {†}_{1} ,$$

$$where {E}_{0} = \vert 0 〉 〈 0 \vert + √ ( 1 - p ) \vert 1 〉 〈 1 \vert , {E}_{1} = √ p \vert 0 〉 〈 1 \vert , and p = 1 - {e}^{- Δ t / T 1} .$$

Subsequently, a dephasing channel is applied and may be expressed as:

$${ρ}^{″} \to ( 1 - p ) {ρ}^{′} + pZ {ρ}^{′} Z ,$$

$$where Z = \vert 0 〉 〈 0 \vert - \vert 1 〉 〈 1 \vert and p = \frac{1}{2} ( 1 - {e}^{- Δ t / T 2} \cdot {e}^{Δ t / 2 T 1} ) .$$

Considering a Bell state |Φ+>=(|00+|11)/2 and ρ=|Φ+><Φ+|, the same formulas as above can be applied with modifications that may result as follows:

$${E}_{0} = \begin{matrix}1 & 0 & 0 & 0 \\ 0 & √ 1 - p & 0 & 0 \\ 0 & 0 & √ 1 - p & 0 \\ 0 & 0 & 0 & 1 - p\end{matrix}$$

$${E}_{1} = \begin{matrix}0 & 0 & 0 & p \\ 0 & 0 & 0 & 0 \\ 0 & 0 & 0 & 0 \\ 0 & 0 & 0 & 0\end{matrix}$$

$$Z = \begin{matrix}1 & 0 & 0 & 0 \\ 0 & - 1 & 0 & 0 \\ 0 & 0 & - 1 & 0 \\ 0 & 0 & 0 & 1\end{matrix}$$

The fidelity of the Bell pairs may be computed in terms of Δt.

Once traffic shape generator 126 of orchestration layer 120 has extracted a traffic shape for each distributed quantum circuit, the orchestration layer instructs entanglement generation switch 142 with respect to when to send EPR pairs and destination QPUs to receive them. This may be accomplished based on the precise traffic shape of the jobs. Entanglement request scheduler 128 modifies the entanglement requests (from the traffic shape) including a fulfillment window based on the QPUs hardware. Entanglement requests of a user must be executed in the original order, and the timing of the request must be respected in an interleaved manner. Further, when one of the entanglement requests of each job fails, the distributed quantum circuit cannot be executed. In addition, entanglement request fulfiller 132 knows the capabilities of the quantum source and reconfigurable optical switch of entanglement generation switch 142, and determines whether or not entanglement requests can be fulfilled. The results in terms of an amount of entanglement requests that can be satisfied are provided back to the entanglement request scheduler until an optimal switch scheduling is identified.

A greedy scheduling technique of an embodiment is designed to efficiently allocate entanglement requests in a quantum network, ensuring that entanglement requests are fulfilled within their specified timing constraints. The greedy scheduling technique ensures that entanglement requests are handled in their original order, respecting interleaved timing requirements. By incorporating hardware constraints and capabilities of the quantum source and reconfigurable optical switch of entanglement generation switch 142, the technique produces a scheduling plan or entanglement resource distribution schedule in terms of trigger events for the reconfigurable optical switch. The technique has operating phases including an initialization phase, a request processing phase, and an acceptance decision-making phase.

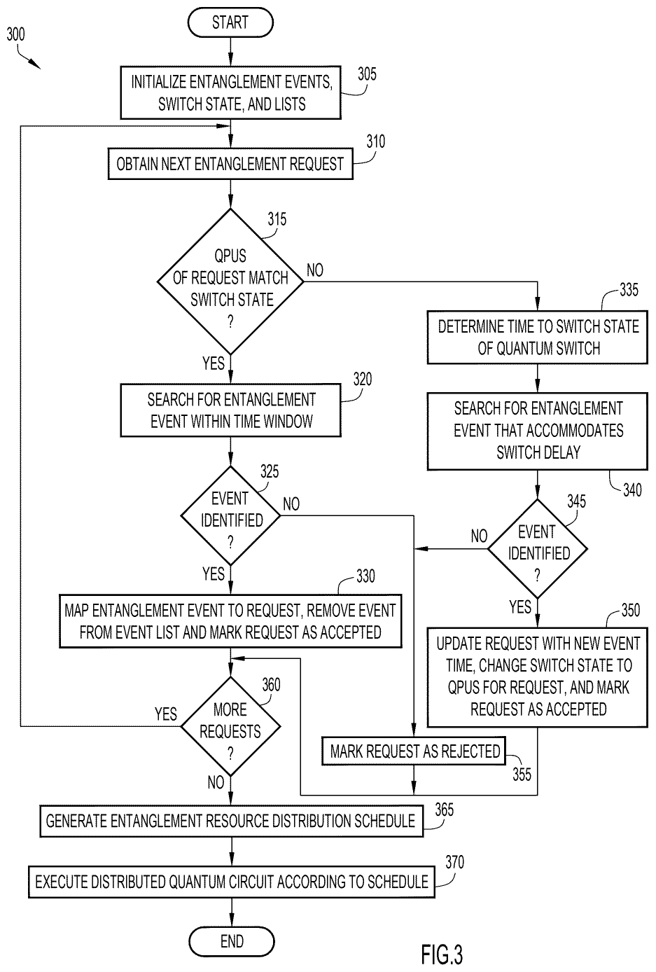

In the initialization phase (FIG. 3), entanglement events are initialized based on earliest and latest entanglement request times. The entanglement events correspond to entanglement or EPR pairs generated by the entanglement source of the entanglement generation switch 142 at a corresponding frequency (or at each time interval). The internal state of the reconfigurable optical switch of the entanglement generation switch 142 is set to match (or direct EPR pairs to) quantum processing units (QPUs) 144 of a first entanglement request. In addition, lists for accepted (or fulfilled) entanglement requests and rejected entanglement requests are also initialized to respectively store the entanglement requests that are successfully scheduled and the entanglement requests that are unable to be scheduled.

In the processing request phase (FIG. 3), each entanglement request is processed sequentially from a list of entanglement requests sorted by time. For each entanglement request, the QPUs specified in the entanglement request are compared to a current state of entanglement generation switch 142. When the QPUs of the entanglement request match the internal state of the entanglement generation switch (e.g., the entanglement generation switch is configured to direct EPR pairs to those QPUs), an entanglement event is mapped or assigned to the entanglement request by the acceptance-decision making phase. Otherwise, the acceptance-decision making phase determines a new entanglement event time for the entanglement request based on changing the state of the entanglement generation switch, changes the state of the entanglement generation switch, and maps or assigns the updated entanglement event to the entanglement request.

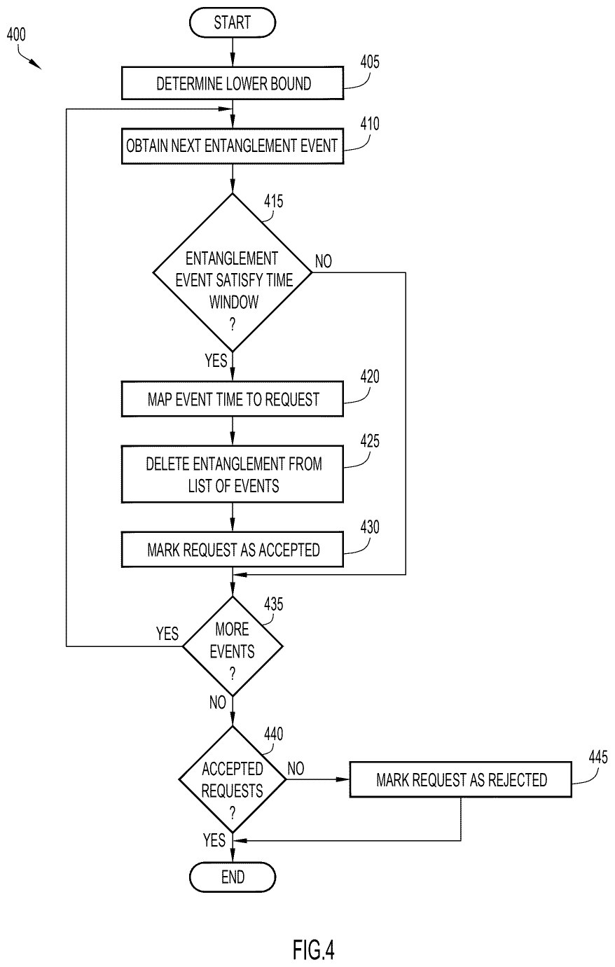

When the QPUs of the entanglement request match the internal state of the entanglement generation switch, the acceptance decision-making phase (FIG. 4) determines a lower bound for an entanglement event time that satisfies an entanglement request. This phase iterates through a list of entanglement events to determine an entanglement event that falls within an acceptable time window. When an entanglement event is identified, the event time is mapped or assigned to the entanglement request, the entanglement event is removed from the list of entanglement events, and the entanglement request as accepted.

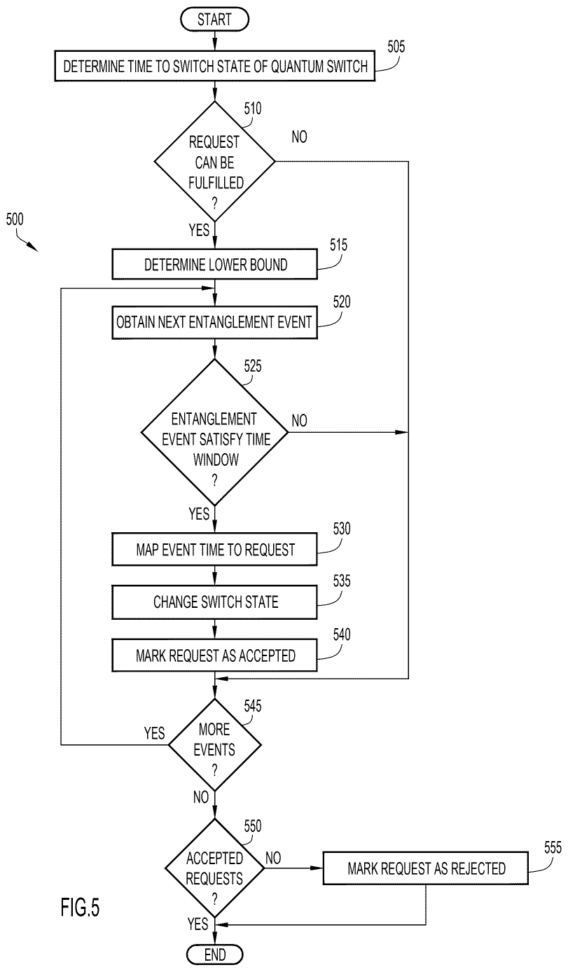

When the QPUs of the entanglement request do not match the internal state of the entanglement generation switch, the acceptance-decision making phase (FIG. 5) calculates a time, t_{switch}, required to change a state of entanglement generation switch 142. The entanglement request is examined to determine whether or not the entanglement request can be fulfilled after the switching time. A lower bound may be determined based on a most recently accepted entanglement request and a current request timing constraints. The phase iterates through the entanglement events to determine a suitable event time that can accommodate the delay from changing the state of the entanglement generation switch. When a suitable event is identified, the entanglement request is updated with the new event time, the state of the entanglement generation switch is changed to required QPUs for the entanglement request, and the entanglement request is marked as accepted.

When an entanglement request is accepted, the entanglement request is appended or otherwise added to the list of accepted entanglement requests. Otherwise, the entanglement request is appended or otherwise added to the list of rejected entanglement requests. The above technique continues until all entanglement requests have been processed, and provides the lists of accepted and rejected entanglement requests.

With continued reference to FIGS. 1 and 2, FIG. 3 illustrates a method 300 for scheduling entanglement based on a greedy technique, according to an example embodiment. Initially, entanglement events, a switch state, and lists for accepted (or fulfilled) and rejected (or unfulfilled) entanglement requests are initialized at operation 305. The entanglement events are initialized based on earliest and latest entanglement request times. The entanglement events correspond to entanglement or EPR pairs generated by the entanglement source of the entanglement generation switch 142 at a corresponding frequency (or at each time interval). The internal state of the reconfigurable optical switch of the entanglement generation switch 142 is set to match (or direct EPR pairs to) quantum processing units (QPUs) 144 of a first entanglement request. In addition, lists for accepted entanglement requests and rejected entanglement requests are also initialized to respectively store the entanglement requests that are successfully scheduled (or accepted) and the entanglement requests that are unable to be scheduled (or rejected).

A next entanglement request is obtained from a list of entanglement requests for a distributed quantum circuit sorted by time at operation 310. The entanglement request preferably specifies QPUs that are to utilize the entanglement resources. The QPUs specified in the entanglement request are compared to a current state of entanglement generation switch 142. When the QPUs of the entanglement request match the current state of the entanglement generation switch (e.g., the entanglement generation switch is configured for the QPUs) as determined at operation 315, a list of entanglement events for entanglement generation switch 142 (e.g., times at which EPR pairs are generated, etc.) is searched to identify an entanglement event within a time window corresponding to a time for the entanglement request at operation 320. In other words, a search is conducted to identify an entanglement event of the entanglement generation switch (or generation of an EPR pair at a corresponding frequency or time) that satisfies the entanglement request.

When an entanglement event that satisfies the entanglement request is identified as determined at operation 325, the identified entanglement event is mapped or assigned to the entanglement request, the entanglement event is removed from the list of entanglement events, and the entanglement request is marked as accepted at operation 330. When an entanglement event is not identified as determined at operation 325, the entanglement request is marked as rejected at operation 355.

When the QPUs of the entanglement request do not match the current state of the entanglement generation switch (e.g., the entanglement generation switch is not configured for the QPUs) as determined at operation 315, a time required to change a state of entanglement generation switch 142 is determined at operation 335. The list of entanglement events for entanglement generation switch 142 (e.g., times at which EPR pairs are generated, etc.) is searched to identify an entanglement event that accommodates the delay from changing the state of the entanglement generation switch at operation 340. In other words, the time of the entanglement request is time-shifted (or adjusted) and a search is conducted to identify an entanglement event of the entanglement generation switch (or generation of an EPR pair) that accommodates the time for the change of state of the entanglement generation switch to satisfy the (time-shifted) entanglement request.

When an entanglement event that satisfied the entanglement request (with the switch delay) is identified as determined at operation 345, the entanglement request is updated with the new entanglement event time (or mapped or assigned to the entanglement event), the state of the entanglement generation switch is changed to required QPUs for the entanglement request, and the entanglement request is marked as accepted at operation 350. When an entanglement event is not identified as determined at operation 345, the entanglement request is marked as rejected at operation 355.

Once the entanglement request has been processed at operations 330, 350, or 355, the above process is repeated with a next entanglement request from operation 310 until the entanglement requests have been processed as determined at operation 360. Once the entanglement requests are processed, a switching plan or entanglement resource distribution schedule for the distributed quantum algorithm or circuit is produced based on the accepted entanglement requests at operation 365. The entanglement generation switch is controlled based on the entanglement resource distribution schedule to generate and distribute EPR pairs to QPUs 144 at appropriate times to execute the distributed quantum circuit at operation 370. The mapped or accepted entanglement requests (and/or schedule) are used to generate control instructions for the entanglement generation switch to control the entanglement generation switch to generate and distribute EPR pairs to QPUs 144 at appropriate times according to the schedule.

With continued reference to FIGS. 1-3, FIG. 4 illustrates a method 400 for determining an entanglement event for an entanglement request, according to an example embodiment. Method 400 may correspond to operations 320, 325, 330, and 355 of FIG. 3. Initially, the QPUs of an entanglement request may match the current state of entanglement generation switch 142 (e.g., the entanglement generation switch is configured for the QPUs) as described above. A lower bound for an entanglement event time that satisfies the entanglement request is determined at operation 405. For example, the lower bound may be a maximum of: 1) zero; and 2) a difference of the entanglement request time and memory or storage time (Δt). A next entanglement event is obtained from the list of entanglement events for entanglement generation switch 142 at operation 410. The entanglement event is examined to determine whether or not a time of the entanglement event (generation of an EPR pair) satisfies the entanglement request (e.g., lower bound≤event time≤request time). When the entanglement event satisfies the entanglement request as determined at operation 415, the entanglement time is mapped or assigned to the entanglement request at operation 420. Further, the entanglement event is removed from the list of entanglement events at operation 425, and the entanglement request is marked as accepted at operation 430.

When the entanglement event does not satisfy the entanglement request as determined at operation 415, or after the entanglement request is marked as accepted at operation 430, the above process is repeated for the next entanglement event from the list from operation 410 until the entanglement events have been processed as determined at operation 435.

In an embodiment, loss properties of hardware may be used to map or assign additional entanglement events to an accepted entanglement request to ensure fulfilment of that request. Thus, an accepted entanglement request may be mapped to one or more entanglement events (based on the searching or iteration through the entanglement events).

When the entanglement request has not been accepted (e.g., no entanglement events have been identified that enable the entanglement request to be accepted) as determined at operation 440, the entanglement request is marked as rejected at operation 445.

With continued reference to FIGS. 1-4, FIG. 5 illustrates a method 500 for determining an entanglement event for an entanglement request based on a time for a quantum switch to change state, according to an example embodiment. Method 500 may correspond to operations 335, 340, 345, 350, and 355 of FIG. 3. Initially, the QPUs of an entanglement request may not match the current state of entanglement generation switch 142 (e.g., the entanglement generation switch is not configured for the QPUs) as described above. A time required to change a state of entanglement generation switch 142 is determined at operation 505.

The entanglement request is examined to determine whether or not the entanglement request can be fulfilled after the switching time. For example, the entanglement request may be fulfilled when the when the time of the entanglement request is greater than or equal to (at or after) the time for changing the state of the entanglement generation switch.

When the entanglement request can be fulfilled as determined at operation 510, a lower bound is determined at operation 515. The lower bound may be based on a most recently accepted entanglement request, timing constraints of a current entanglement request, properties of quantum memories of quantum computers, and/or a user-specified minimum fidelity. The lower bound may represent a maximum time ahead for an entanglement request for sending and storing quantum entanglement. A user is allowed to specify their needed entanglement fidelity or threshold. For example, when a prior entanglement request has been accepted, the lower bound may be determined as a maximum of: 1) the assigned time of the entanglement event for the prior accepted entanglement request; and 2) the result of subtracting the time for changing the state and the storage time (or time in quantum memory of an EPR pair) from the time for the entanglement request. When no prior accepted entanglement request exists, the lower bound may be determined as the maximum of: 1) zero; and 2) the result of subtracting the time for changing the state and the storage time (or time in quantum memory of an EPR pair) from the time for the entanglement request. The user-specified minimum fidelity may further be applied to (e.g., subtracted from, etc.) the determined lower bound to account for the user-specified minimum fidelity.

A next entanglement event is obtained from the list of entanglement events for entanglement generation switch 142 at operation 520. The entanglement event is examined to determine whether or not a time of the entanglement event satisfies a time for the entanglement request that can accommodate the delay from changing the state of the entanglement generation switch (e.g., lower bound≤event time≤request time−switch time). When the entanglement event satisfies the entanglement request as determined at operation 525, the entanglement event (and/or time) is mapped or assigned to the entanglement request at operation 530. Further, the state of the entanglement generation switch is changed to required QPUs for the entanglement request at operation 535, and the entanglement request is marked as accepted at operation 540.

When the entanglement event does not satisfy the entanglement request as determined at operation 525, or after the entanglement request is marked as accepted at operation 540, the above process is repeated for the next entanglement event from the list from operation 520 until the entanglement events have been processed as determined at operation 545.

In an embodiment, loss properties of hardware may be used to map or assign additional entanglement events to an accepted entanglement request to ensure fulfilment of that request. Thus, an accepted entanglement request may be mapped to one or more entanglement events (based on the searching or iteration through the entanglement events).

When the entanglement request has not been accepted (e.g., no entanglement events have been identified that enable the entanglement request to be accepted) as determined at operation 550, the entanglement request is marked as rejected at operation 555.

A technique according to an example embodiment was simulated. In particular, the simulation pertained to a quantum datacenter composed of: (i) M quantum processing units, each with di (where i=1, . . . , M) number of processing qubits and one communication qubit; (ii) a continuous entanglement source that generates entangled pairs with a frequency fₑₚᵣ; and (iii) a reconfigurable 2×M optical switch. For the generation of the traffic shape, a time duration of the single-qubit and two-qubit gates was set to 5 ns and 50 ns, respectively. The switch reconfiguration time is 2 ns for a single output line change and 10 ns for a double output line change.

In an example scenario, a single user submits a Quantum Fourier Transform (QFT) task to the quantum datacenter, which needs to be executed by distributing the QFT task to M=2 QPUs, each having d=2 data qubits. After compiling the QFT circuit, the result includes a total of 18 entanglement requests that need to be satisfied to execute the circuit.

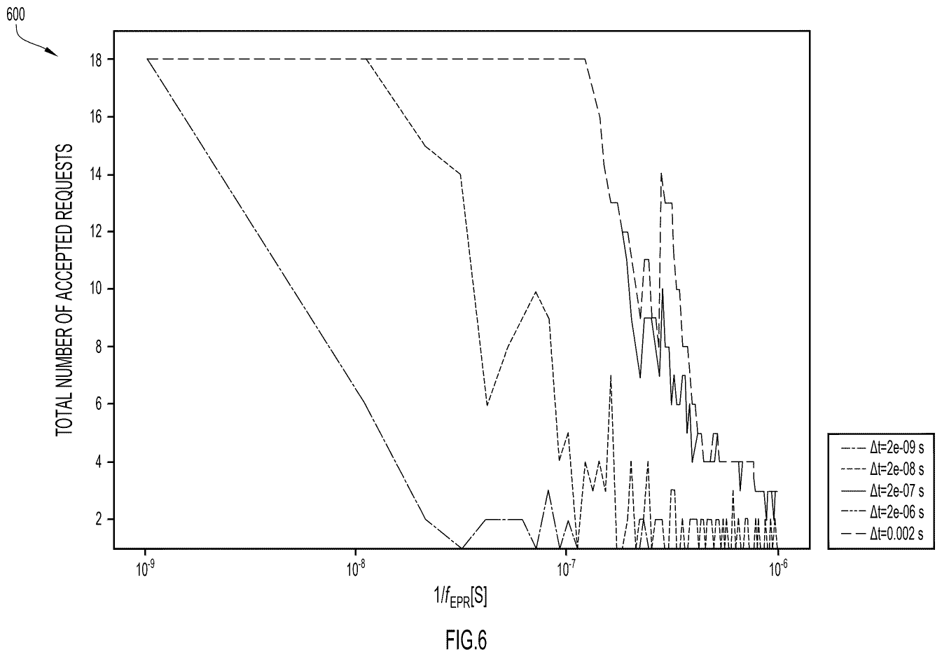

With continued reference to FIGS. 1-5, FIG. 6 illustrates results of assigning entanglement resources to entanglement requests produced by an example embodiment for the example scenario. The results are presented in a graphical plot 600. Graphical plot 600 includes an X-axis representing the inverse of the frequency of EPR pair generation (1/fₑₚᵣ), a Y-axis representing the number of accepted entanglement requests, and plural plots each associated with a different storage (or quantum memory) time for an EPR pair. When fₑₚᵣ increases, there is a greater probability that an entanglement request can be fulfilled, and this probability increases with storage time. This is due to the fact that a higher frequency of EPR events results in more events falling within the time window for an entanglement request, even when considering switch dead time. Conversely, when the fₑₚᵣ decreases, the number of available EPR events becomes lower, reducing the probability of fulfilling requests. As a result, fewer requests can be accepted.

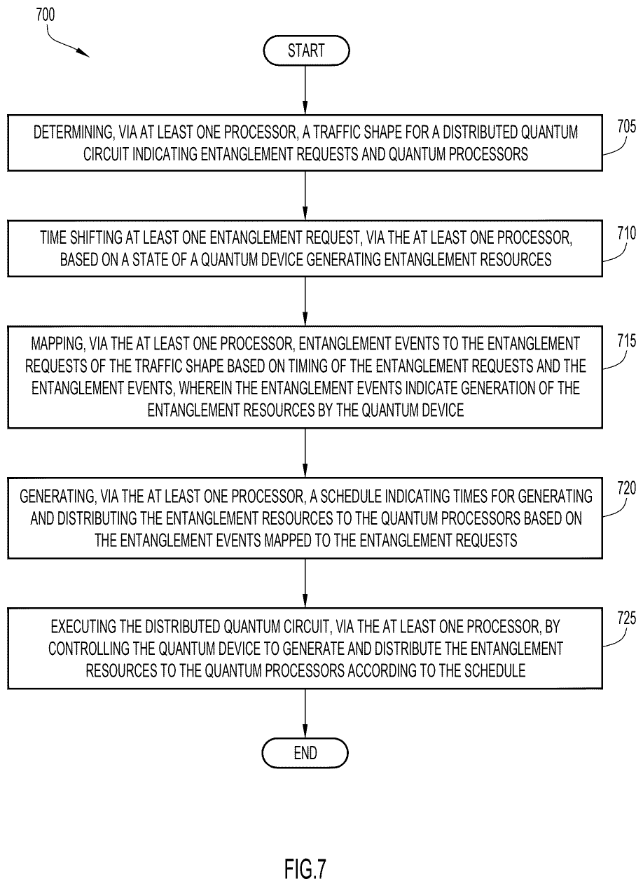

FIG. 7 illustrates a flowchart of a generalized method 700 for distribution of entanglement resources for a distributed quantum circuit, according to an example embodiment. At operation 705, at least one processor determines a traffic shape for a distributed quantum circuit indicating entanglement requests and quantum processors. At operation 710, the at least one processor time shifts at least one entanglement request based on a state of a quantum device generating entanglement resources. At operation 715, the at least one processor maps entanglement events to the entanglement requests of the traffic shape based on timing of the entanglement requests and the entanglement events. The entanglement events indicate generation of the entanglement resources by the quantum device. At operation 720, the at least one processor generates a schedule indicating times for generating and distributing the entanglement resources to the quantum processors based on the entanglement events mapped to the entanglement requests. At operation 725, the at least one processor executes the distributed quantum circuit by controlling the quantum device to generate and distribute the entanglement resources to the quantum processors according to the schedule.

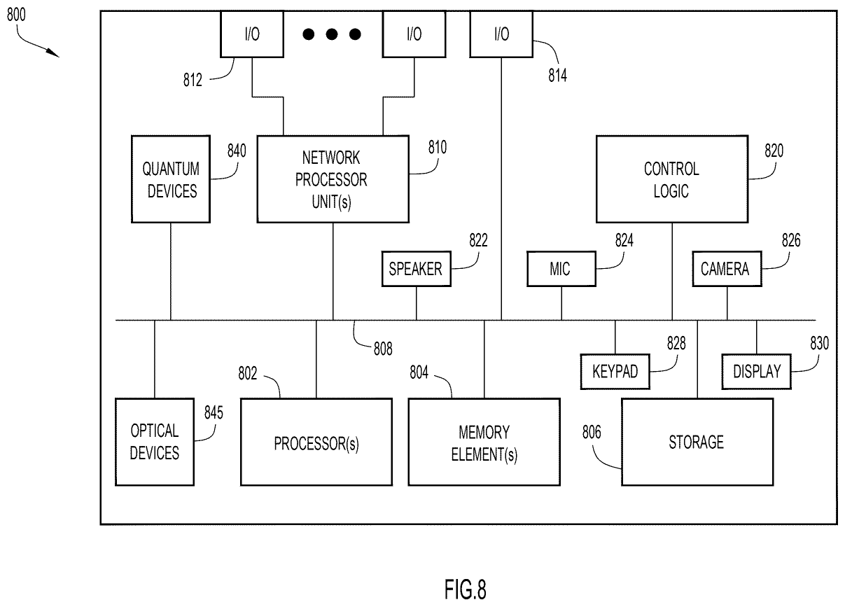

Referring to FIG. 8, FIG. 8 illustrates a hardware block diagram of a computing device 800 that may perform functions associated with operations discussed herein in connection with the techniques depicted in FIGS. 1-7. In various embodiments, a computing device or apparatus or system, such as computing device 800 or any combination of computing devices 800, may be configured as any device entity/entities (e.g., network nodes, computer devices, user devices, client devices, communication devices, network devices, processors, switching devices, network interfaces, quantum nodes, etc.) as discussed for the techniques depicted in connection with FIGS. 1-7 in order to perform operations of the various techniques discussed herein.

In at least one embodiment, computing device 800 may be any apparatus that may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory elements 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interfaces 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, network device, network nodes, processors, network interfaces, switching devices, quantum nodes, etc.), computing device 800 may further include, or be coupled to, a speaker 822 to convey sound, microphone or other sound sensing device 824, camera or image capture device 826, a keypad or keyboard 828 to enter information (e.g., alphanumeric information, etc.), a touch screen or other display 830, quantum devices 840, and/or optical devices 845. These items may be coupled to bus 808 or I/O interface(s) 814 to transfer data with other elements of computing device 800. Quantum devices 840 may include any conventional or other devices to perform the functions described herein (e.g., generating, transmitting, receiving, entangling, and/or processing quantum signals and/or keys), such as a quantum source, quantum transmitters and receivers, quantum channels, a source of randomness, lasers or other energy sources, quantum measuring devices, quantum logic or other gates or circuits, quantum memories, quantum processors, quantum buffers, quantum switches, etc. Optical devices 845 may include any conventional or other optical devices to perform the functions described herein (e.g., generating, transmitting, receiving, and/or processing classical or other optical signals), such as optical switches, optical transmitters and receivers, optical multiplexers or other switching devices, etc.

In various embodiments, control logic 820 can include instructions that, when executed, cause processor(s) 802 to perform operations, which can include, but not be limited to, providing overall control operations of computing device 800; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory elements 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: determining, via at least one processor, a traffic shape for a distributed quantum circuit indicating entanglement requests and quantum processors; time shifting at least one entanglement request, via the at least one processor, based on a state of a quantum device generating entanglement resources; mapping, via the at least one processor, entanglement events to the entanglement requests of the traffic shape based on timing of the entanglement requests and the entanglement events, wherein the entanglement events indicate generation of the entanglement resources by the quantum device; generating, via the at least one processor, a schedule indicating times for generating and distributing the entanglement resources to the quantum processors based on the entanglement events mapped to the entanglement requests; and executing the distributed quantum circuit, via the at least one processor, by controlling the quantum device to generate and distribute the entanglement resources to the quantum processors according to the schedule.

In one example, the entanglement events are mapped to the entanglement requests based on a frequency of generation of the entanglement events.

In one example, time shifting at least one entanglement request comprises determining a maximum time ahead for the at least one entanglement request to be sent and stored based on properties of quantum memories and a user specified tolerance.

In one example, the method further comprises mapping, via the at least one processor, additional entanglement events to an entanglement request to ensure fulfillment of the entanglement request.

In one example, the method further comprises generating, via the at least one processor, additional fulfilled entanglement requests by re-processing rejected entanglement requests of the traffic shape.

In one example, the method further comprises minimizing runtime of the distributed quantum circuit, via the at least one processor, by determining combinations of jobs to execute simultaneously based on the entanglement requests.

In one example, executing the distributed quantum circuit comprises generating control instructions to control the quantum device to generate and distribute the entanglement resources to the quantum processors.

In another form, an apparatus is provided. The apparatus comprises a network interface; memory; and at least one processor configured to perform operations comprising: determining a traffic shape for a distributed quantum circuit indicating entanglement requests and quantum processors; time shifting at least one entanglement request based on a state of a quantum device generating entanglement resources; mapping entanglement events to the entanglement requests of the traffic shape based on timing of the entanglement requests and the entanglement events, wherein the entanglement events indicate generation of the entanglement resources by the quantum device; generating a schedule indicating times for generating and distributing the entanglement resources to the quantum processors based on the entanglement events mapped to the entanglement requests; and executing the distributed quantum circuit by controlling the quantum device to generate and distribute the entanglement resources to the quantum processors according to the schedule.

In another form, one or more non-transitory computer readable storage media are provided. The one or more non-transitory computer readable storage media are encoded with processing instructions that, when executed by one or more processors, cause the one or more processors to: determine a traffic shape for a distributed quantum circuit indicating entanglement requests and quantum processors; time shift at least one entanglement request based on a state of a quantum device generating entanglement resources; map entanglement events to the entanglement requests of the traffic shape based on timing of the entanglement requests and the entanglement events, wherein the entanglement events indicate generation of the entanglement resources by the quantum device; generate a schedule indicating times for generating and distributing the entanglement resources to the quantum processors based on the entanglement events mapped to the entanglement requests; and execute the distributed quantum circuit by controlling the quantum device to generate and distribute the entanglement resources to the quantum processors according to the schedule.

The description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
determining, via at least one processor, a traffic shape for a distributed quantum circuit indicating entanglement requests and quantum processors;
time shifting at least one entanglement request, via the at least one processor, based on a state of a quantum device generating entanglement resources;
mapping, via the at least one processor, entanglement events to the entanglement requests of the traffic shape based on timing of the entanglement requests and the entanglement events, wherein the entanglement events indicate generation of the entanglement resources by the quantum device;
generating, via the at least one processor, a schedule indicating times for generating and distributing the entanglement resources to the quantum processors based on the entanglement events mapped to the entanglement requests; and
executing the distributed quantum circuit, via the at least one processor, by controlling the quantum device to generate and distribute the entanglement resources to the quantum processors according to the schedule.

2. The method of claim 1, wherein the entanglement events are mapped to the entanglement requests based on a frequency of generation of the entanglement events.

3. The method of claim 1, wherein time shifting at least one entanglement request comprises:
determining a maximum time ahead for the at least one entanglement request to be sent and stored based on properties of quantum memories and a user specified tolerance.

4. The method of claim 1, further comprising:
mapping, via the at least one processor, additional entanglement events to an entanglement request to ensure fulfillment of the entanglement request.

5. The method of claim 1, further comprising:
generating, via the at least one processor, additional fulfilled entanglement requests by re-processing rejected entanglement requests of the traffic shape.

6. The method of claim 1, further comprising:
minimizing runtime of the distributed quantum circuit, via the at least one processor, by determining combinations of jobs to execute simultaneously based on the entanglement requests.

7. The method of claim 1, wherein executing the distributed quantum circuit comprises:
generating control instructions to control the quantum device to generate and distribute the entanglement resources to the quantum processors.

8. An apparatus comprising:
a network interface;
memory; and
at least one processor configured to perform operations comprising:
determining a traffic shape for a distributed quantum circuit indicating entanglement requests and quantum processors;
time shifting at least one entanglement request based on a state of a quantum device generating entanglement resources;
mapping entanglement events to the entanglement requests of the traffic shape based on timing of the entanglement requests and the entanglement events, wherein the entanglement events indicate generation of the entanglement resources by the quantum device;
generating a schedule indicating times for generating and distributing the entanglement resources to the quantum processors based on the entanglement events mapped to the entanglement requests; and
executing the distributed quantum circuit by controlling the quantum device to generate and distribute the entanglement resources to the quantum processors according to the schedule.

9. The apparatus of claim 8, wherein the entanglement events are mapped to the entanglement requests based on a frequency of generation of the entanglement events.

10. The apparatus of claim 8, wherein time shifting at least one entanglement request comprises:
determining a maximum time ahead for the at least one entanglement request to be sent and stored based on properties of quantum memories and a user specified tolerance.

11. The apparatus of claim 8, wherein the at least one processor is further configured to perform operations comprising:
mapping additional entanglement events to an entanglement request to ensure fulfillment of the entanglement request.

12. The apparatus of claim 8, wherein the at least one processor is further configured to perform operations comprising:
generating additional fulfilled entanglement requests by re-processing rejected entanglement requests of the traffic shape.

13. The apparatus of claim 8, wherein the at least one processor is further configured to perform operations comprising:
minimizing runtime of the distributed quantum circuit by determining combinations of jobs to execute simultaneously based on the entanglement requests.

14. One or more computer readable storage media encoded with processing instructions that, when executed by one or more processors, cause the one or more processors to:
determine a traffic shape for a distributed quantum circuit indicating entanglement requests and quantum processors;
time shift at least one entanglement request based on a state of a quantum device generating entanglement resources;
map entanglement events to the entanglement requests of the traffic shape based on timing of the entanglement requests and the entanglement events, wherein the entanglement events indicate generation of the entanglement resources by the quantum device;
generate a schedule indicating times for generating and distributing the entanglement resources to the quantum processors based on the entanglement events mapped to the entanglement requests; and
execute the distributed quantum circuit by controlling the quantum device to generate and distribute the entanglement resources to the quantum processors according to the schedule.

15. The one or more computer readable storage media of claim 14, wherein the entanglement events are mapped to the entanglement requests based on a frequency of generation of the entanglement events.

16. The one or more computer readable storage media of claim 14, wherein time shifting at least one entanglement request comprises:
determining a maximum time ahead for the at least one entanglement request to be sent and stored based on properties of quantum memories and a user specified tolerance.

17. The one or more computer readable storage media of claim 14, wherein the processing instructions further cause the one or more processors to:
map additional entanglement events to an entanglement request to ensure fulfillment of the entanglement request.

18. The one or more computer readable storage media of claim 14, wherein the processing instructions further cause the one or more processors to:
generate additional fulfilled entanglement requests by re-processing rejected entanglement requests of the traffic shape.

19. The one or more computer readable storage media of claim 14, wherein the processing instructions further cause the one or more processors to:
minimize runtime of the distributed quantum circuit by determining combinations of jobs to execute simultaneously based on the entanglement requests.

20. The one or more computer readable storage media of claim 14, wherein executing the distributed quantum circuit comprises:
generating control instructions to control the quantum device to generate and distribute the entanglement resources to the quantum processors.
